(19) United States
(12) Patent Application Publication
(10) Pub. No.: US 2003/0126570 A1
(43) Pub. Date: Jul. 3, 2003

(54) Systems and methods for realizing integrated circuits

(76) Inventors: Tan Du, Plano, TX (US); James Lee Conner, Rockwall, TX (US); James Albert Holmes, Lucas, TX (US)

Correspondence Address: TEXAS INSTRUMENTS INCORPORATED, P O BOX 655474, M/S 3999, DALLAS, TX, 75265

(21) Appl. No.: 10/326,133

(22) Filed: Dec. 20, 2002

Related U.S. Application Data
(60) Provisional application No. 60/344,202, filed on Dec. 28, 2001.

(51) Int. Cl. G06F 9/45; G06F 17/50

(52) U.S. Cl. 716/8

(57) ABSTRACT

Disclosed are systems and methods for realizing a selected semiconductor device design using a virtual IC to model the design and simulate characterization and testing for further development of the design prior to the fabrication of actual semiconductor devices. According to the disclosed embodiments of the invention, a common platform may be used for design and simulation phases of IC development.

### RELATED APPLICATIONS

This application claims priority based on Provisional Patent Application No. 60/344,202, filed Dec. 28, 2001. This application and the aforementioned provisional application have at least one common inventor and are assigned to the same entity.

### TECHNICAL FIELD

The invention relates to systems and methods for realizing integrated circuit designs. More particularly, the invention relates to methods for designing and realizing integrated circuits including simulation, characterization, and testing of virtual ICs prior to actual semiconductor device implementation.

### BACKGROUND

A challenge that every semiconductor company faces is to shorten the manufacturing cycle in order to meet increasing customer demand for quick delivery of IC chips. Apart from the fabrication process, this requires that design specifications be fully checked before and during circuit design. Accordingly, it is desirable to simulate schematic designs not only at the block-level, but also at the whole-chip level for the purpose of attaining first-pass success and reducing turnover. It is difficult to simulate a large chip with a large amount of analog circuitry because current Electronics Design Automation (EDA) tools are slow in transistor-level simulation. Due to the expense associated with manufacturing, for efficiency, the test-device and code development must be fully debugged and tested before actual silicon comes out. A lack of chip block models acceptable for current test and characterization platforms make the early debugging of code and testing of devices difficult.

Other problems arise in attempting to integrate simulation methods used in different phases of the development process. It is not uncommon for resources to be wasted when different elements of the process, e.g. systems, design, characterization, or test, use different test vectors, each using different models and simulators for the same blocks. Moreover, models of devices are often written in languages specific to a particular simulator platform and incompatible with other platforms. Also, most modeling and simulation tools are not transparent to designers, limiting flexibility to adapt to new designs. These problems are particularly acute when the chip is of a mixed-signal type, having both digital and analog components. The analog part of a mixed-signal chip is generally more difficult to simulate than the digital portion.

So-called advanced mixed-signal (AMS) simulators known in the arts attempt to co-simulate analog and digital portion of a mixed-signal system in parallel. Using this approach, separate platforms are used for simulating analog and digital portions of the system, and the results are combined to provide an overall system result. Such attempts at mixed-signal simulations are plagued by slow run times and by their limitation to functional level simulation only, as opposed to the transistor level simulations often desired by system designers. At their best, AMS simulators known in the arts may contribute to the design of an IC, but not to testing and characterization for further development of the design.

These and other problems are further addressed in related patent application, Ser. No. 10/242,028, filed on Sep. 11, 2002, and the patent application of Du entitled, “System Simulation Using Dynamic Step Size and Iterative Model” (Attorney Docket Number TI-33301), filed contemporaneously with the present application, which are both incorporated herein for all purposes by this reference.

Other examples of problems in the arts include the required use of multiple netlists in the simulation of design and in the implementation of a single IC. For example, one netlist may suffice for producing a digital simulation of a portion of a given design, yet another netlist may be required for an analog simulation of another portion of the design. Both simulations may be useful in designing the digital and analog portions of the IC, but the development of incompatible netlists for use with simulators using different platforms is inefficient and increases potential for error. The similar case arises when doing IC behavior level simulation using a simulator for example Verilog-AMS and when doing IC transistor level simulation using a simulator like Spice.

The progression among phases of the IC design and development process commonly used in the arts is essentially linear. System requirements are initially determined. The specification is analyzed and expected IC internal circuitry is partitioned into blocks for the ease of design and verification. All of the blocks, digital, analog or mixed-signal are designed concurrently, supported by various simulation tools and process database. Incompatible netlists result in slow completion of schematic and layout design. This stage is followed by the fabrication or manufacture of a test lot of semiconductor devices. The ICs thus produced are then probe tested to verify general compliance with the intended design. Subsequently, the IC dies are separated from the wafer and packaged to produce prototype semiconductor devices for chip testing. Chip testing generally includes bench characterization to verify compliance of major functionality with the design. Any bugs found in probe test and bench characterization are fed back into the design process to influence the design of the appropriate block. Re-fabrication of test chips is often required until all the chip specifications are met. Volume production testing then ensures a sufficient statistical parameter compliance with system requirements and circuit functionality during the high-volume manufacturing of the completed semiconductor device.

The procedures and programs for probe tests, bench characterization and final volume production tests are developed in parallel with the chip schematic design. However, In the prior art all the actual test equipment cannot be properly debugged until an actual silicon IC is fabricated. Often days or weeks are required to finalize and tune the testing equipment upon fabrication of the fist batch of silicon. The need to produce a prospective design in actual silicon form results in a potentially costly bottleneck in the process of designing and ultimately realizing a mass-produced IC device.

Processes for realizing system designs using an all-purpose mixed-signal model and simulation engine for electronic systems would be highly useful and advantageous in the arts. Solutions to the above and other problems would use a common high-level language for modeling analog and digital systems for simulation and design development. Useful advantages would inhere in a process for developing and using a virtual semiconductor device for the development of an IC. Such a process would use virtual devices in the systems, design, characterization, and testing phases of IC design implementation, resulting in decreased development time and reduced costs enabling the advanced development of a design prior to the actual production of the first semiconductor devices.

### SUMMARY OF THE INVENTION

In general, the invention provides systems and methods for realizing a selected semiconductor device design using a virtual IC to model the design. This virtual IC is used for the verification of actual transistor-level design, and for the development of characterization and testing equipment prior to the fabrication of actual semiconductor devices.

According to a preferred embodiment of the invention, a method for realizing an IC design is disclosed which includes steps of describing an IC design and obtaining a standard step response for the IC design. Using sophisticated techniques, the IC is modeled using the standard step response and can be run in a simulation engine with any standard computer language. In a further step, the model is used in IC design for block simulation using the same single netlist describing the completed IC design at the transistor level simulation.

According to a further aspect of the invention, characterization of the IC is accomplished prior to actual IC production.

According to another aspect of the invention, testing of the IC is accomplished prior to actual IC production.

According to still another aspect of the invention, modifications are made to the IC design prior to actual IC production using characterization and testing results from a virtual IC.

According to yet further aspects of the invention, an embodiment is disclosed in which a system for realizing an IC design includes virtual IC means for simulating characterization and testing of the IC design as well as means for producing IC devices from the design.

### BRIEF DESCRIPTION OF THE FIGURES

FIG. 1 is a block diagram depicting an example of systems and methods of realizing an IC using a virtual IC according to the invention; and

FIG. 2 is a process flow diagram showing an example of a graphical view of a method of the invention.

### DETAILED DESCRIPTION OF PREFERRED EMBODIMENTS

The invention will be better understood in light of the following detailed description and examples. Of course, the examples herein are illustrative only. Many alternative embodiments are possible. From the examples shown, the broader scope of application of the concepts of the invention should be apparent to those skilled in the arts.

Preferably, iterative modeling methods as described in the related applications of Du are used for determining the response of a system to an arbitrary input at the accuracy level required for simulation of the IC system. The modeling and simulation systems, algorithms and methods may be implemented in the form of software, hardware, or a combination of hardware and software. The model is preferably written in a common high-level language, such as a commonly used object-oriented programming language, to run on any platform accepting the common language. The model requires only the saved data points of a standard step response to calculate the output y(t) of the system, corresponding to an arbitrary input x(t). The standard step response data may be obtained from known simulation software, bench tests, ideal system estimation, transfer functions etc., for use with the invention.

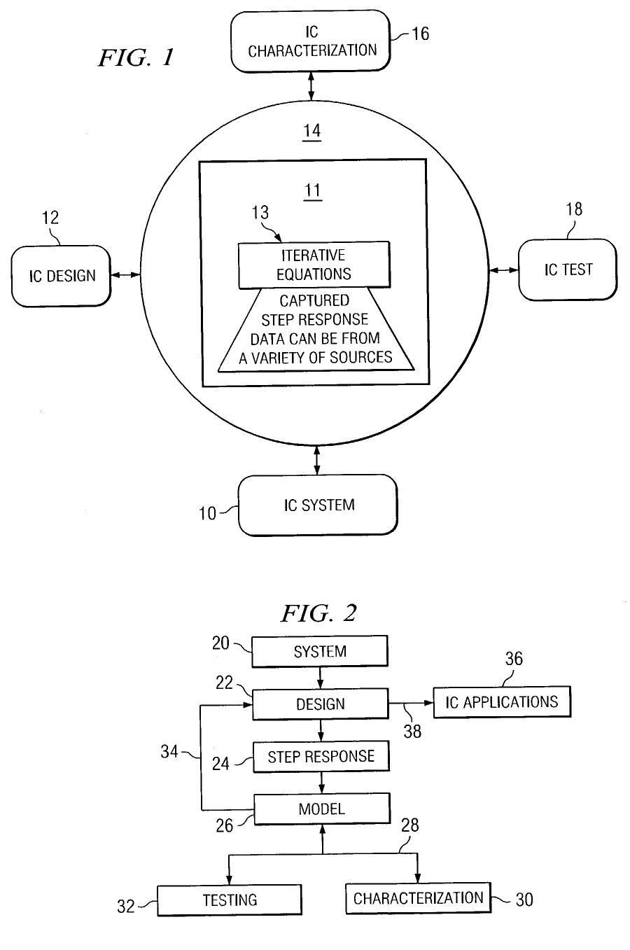

FIG. 1 is a block diagram providing a conceptual view of the systems and methods of the invention. The invention provides a form of virtual IC (or its blocks) 14 for modeling and simulation of a silicon IC or its blocks. The virtual IC preferably includes an IC model 13 and a simulation engine 11 as exemplified in the related applications of Du. (application Ser. No. 10/242,028 and attorney docket number 33301). This virtual IC 14 may take the form of either software or hardware. The preferred form is software written in a common object-oriented programming language that can run on any platform as long as the application can provide a computation environment. One example is an IC design process 12 where the designed schematic and layout must be fully verified. Other examples include IC probe, or volume production testing 18, IC bench characterization 16, or various IC system applications 10 where the IC plus an associated system are employed together to fulfill a meaningful purpose. Of course, the term “virtual IC” is not used in a limiting sense, but encompasses semiconductor circuits and devices in general as known in the arts. The modeling 13 and simulation 11 techniques provide for advanced phases of development of the IC prior to the fabrication of actual IC devices. Significantly, characterization 16, testing 18, and ultimately design 12 modifications may be achieved using the virtual IC 14 relatively early in the IC development process. Preferably, design modifications 12 may be followed by further characterization 16 and testing 18. It should be appreciated that the use of the virtual IC 14 techniques of the invention is not restricted by any requirement for the fabrication of actual IC devices. The a virtual IC 14 may alternatively provide for the development of a complex IC in its entirety, or for the development of individual block or sub-blocks within a larger system.

Typically, an IC system 10 is desired for a particular application need. Prospective designs and their iterative modification lead to a design 12 for implementation. Using modeling techniques, preferably those described in the related applications of Du incorporated herein by reference, a standard step response is used to model the whole design or a portion of a design. A design portion, once modeled to be a virtual IC, can be used to replace the corresponding transistor block(s) inside the original design 12. Simulations are then preferably performed using the model, to speed up the design and verification process. One or more simulations or partial simulations of the design 12 may be used to devise and debug characterization 16 and testing 18 procedures for use with the device design 12. The characterization 16 and testing 18 results are then preferably used to modify the design 12, if necessary, to meet system 10 requirements.

The invention enables the advanced development of an IC to proceed as soon as a design 12 is determined and before the fabrication of test chips. The test code development and debugging is performed based on a virtual IC 14 modeling. Preferably, the testing 18 encompasses one or more procedures substantially simulating probe testing and volume production testing. The simulations may be performed at either the functional level or transistor level without departure from the invention.

The virtual IC 14 of the invention preferably provides a replacement for any transistor-level block without changes to a transistor-level netlist as long as the netlister retains the hierarchical structure of the schematic. Furthermore, the transistor level simulation and the virtual IC 14 behavior level simulation may be swapped during the execution of a simulation. Thus, a common simulation platform may be used for all phases of characterization 16 and testing 18 of a design 12. Of course, the virtual IC 14 of the invention may be used for characterization 16, testing 18, and design 12 modification in any sequence and in numerous iterations according to user requirements. Thus, IC implementation using the invention is not dependent upon a linear progression through a particular sequence of steps, particularly the production of actual IC devices for test, but the development sequence may be varied.

FIG. 2 is a process flow diagram further illustrating an example of a method of realizing an IC design according to the invention. As shown in step 20, IC system requirements are determined. A design is determined, as indicated in step 22, for meeting the system requirements. Using the design, shown at step 24, the standard step response of the system described by the design is obtained. As indicated at step 26, the design of the system is modeled, preferably using the techniques described by Du. As indicated by the multiple branches of arrow 28, the model is used to perform further development steps such as characterization 30 and testing 32. As shown by arrow path 34, the design step 22 may be returned to for system design modifications or simulation speed adjustments based on the modeling 26. A common netlist is used in the loop between steps 22, 24, 26 following path 34. As shown by arrow path 38, the design may be used in an IC application, step 36, such as further development of a larger system using the virtual IC or its functional blocks, or ultimately for chip manufacturing.

Thus the invention provides methods and systems for IC implementation that provide numerous advantages by allowing IC development to advance prior to the fabrication of IC devices. By using virtual ICs for IC development, the invention provides for ultimate IC implementation that is faster and more adaptable across platforms than previously available in the art. Although the implementation examples shown and described demonstrate results based on a specific application of the invention, they are not intended to limit the scope of the invention. The invention can be implemented using various simulation platforms that use common high-level languages. Even though numerous characteristics and advantages of the present invention have been set forth in the foregoing description together with examples of the inventions, the disclosure is illustrative only and changes may be made within the principles of the invention to the full extent indicated by the broad general meaning of the terms used in the attached claims.

We claim:

1. A method for realizing an IC design comprising the steps of:
describing an IC design using a transistor level netlist;
obtaining a standard step response for the IC design;
modeling the IC using the standard step response; and
using the model to replace transistor level circuitry without change to the transistor level netlist of the IC design.

2. The method according to claim 1 further comprising the step of characterizing the IC design using the model.

3. The method according to claim 1 further comprising the step of testing the IC design using the model.

4. The method according to claim 1 further comprising the step of modifying the IC design using the model.

5. The method according to claim 4 further comprising reiterating the obtaining step.

6. The method according to claim 4 further comprising reiterating the modeling step.

7. The method according to claim 4 further comprising reiterating the generating step.

8. The method according to claim 1 further comprising the step of fabricating an IC using the netlist.

9. A system for realizing an IC design comprising:
virtual IC means for simulating characterization and test of the IC design; and
means for producing IC devices using the IC design.

10. The system according to claim 9 wherein the virtual IC means further comprises means for modeling the IC design using a standard step response.

11. The system according to claim 10 wherein the virtual IC means further comprises means for modeling the IC design using a standard step response using a variable step size.

12. The system according to claim 9 further comprising means for modifying the IC design using the simulated characterization.

13. The system according to claim 12 further comprising means for reiterating simulated characterization and testing.

14. The system according to claim 9 further comprising means for modifying the IC design using the simulated test.

15. The system according to claim 14 further comprising means for reiterating simulated characterization and testing.

16. A method for implementing an IC design comprising the steps of:
describing an IC design;
obtaining a standard step response for the IC design;
modeling the IC using the standard step response;
using the model to replace transistor level circuitry to simulate the IC design; and
fabricating an IC using the design.

17. The method according to claim 16 further comprising the step of characterizing the IC design using the model.

18. The method according to claim 16 further comprising the step of testing the IC design using the model.

18. The method according to claim 16 further comprising the step of modifying the IC design using the model.

19. The method according to claim 16 further comprising the step of describing the design using a netlist.

20. The method according to claim 16 further comprising the step of fabricating the design using a netlist.
